(19) United States
(12) Patent Application Publication
(10) Pub. No.: US 2012/0008960 A1
(43) Pub. Date: Jan. 12, 2012

(54) REMOTE CONTROL RECEIVER AND PROJECTION DISPLAY DEVICE

(75) Inventors: Atsushi KUBO, Osaka (JP); Tsutomu Yoshikawa, Osaka (JP); Taichi Yoshimura, Osaka (JP)

(73) Assignee: SANYO Electric Co., Ltd., Osaka (JP)

(21) Appl. No.: 13/167,112

(22) Filed: Jun. 23, 2011

(30) Foreign Application Priority Data
Jul. 6, 2010 (JP) 2010-154345

(51) Int. Cl. H04B 10/00

(52) U.S. Cl. 398/106

(57) ABSTRACT

A remote control receiver which receives light for exercising remote control as a transmission signal, includes: a light detector which receives the transmission signal; and a guide portion which has an incidence plane to which the transmission signal is entered, and refracts the incident transmission signal from the incidence plane and directs the incident transmission signal toward the light detector. In this arrangement, the guide portion has an interface which is tapered down from the incidence plane toward the light detector.

This application claims priority under 35 U.S.C. Section 119 of Japanese Patent Application No. 2010-154345 filed Jul. 6, 2010, entitled “REMOTE CONTROL RECEIVER AND PROJECTION DISPLAY DEVICE”. The disclosure of the above application is incorporated herein by reference.

### BACKGROUND OF THE INVENTION

1. Field of the Invention

The present invention relates to remote control receivers which receive transmission signals for remote control. The present invention also relates to projection display devices equipped with remote control receivers.

2. Disclosure of Related Art

Conventionally, many of projection display devices (hereinafter, called as “projectors”) such as liquid crystal projectors are configured to have remote control receivers which allow the projectors to be remotely operated by transmission signals from remote control transmitters (for example, signal light of infrared rays).

If a projector is installed on a floor surface or a desktop, it is conceived that the projector is remotely operated from front, rear, right, and left sides thereof. In general, the range of receivable angles of a remote control receiver is not very wide. Accordingly, a plurality of remote control receivers is needed to receive transmission signals from a wide area.

Thus, for a projector with one remote control receiver to receive transmission signals from a wide area, there is suggested an arrangement in which a transmission signal having reached a light-receiving window of a main body cabinet is refracted and directed toward a light-receiving portion of the remote control receiver. This arrangement includes a light-guiding member which guides transmission signals to the light-receiving portion and a reflection member which is disposed around the light-guiding member and reflects and directs the transmission signals emitted from a peripheral surface of the light-guiding member toward the light-receiving portion.

However, the foregoing arrangement needs separately the reflection member and the light-guiding member, and thus is likely to become high in cost and complicated in structure.

### SUMMARY OF THE INVENTION

A first aspect of the present invention relates to a remote control receiver which receives light for exercising remote control as a transmission signal. The remote control receiver according to the first aspect includes: a light detector which receives the transmission signal; and a guide portion which has an incidence plane to which the transmission signal is entered, and refracts the incident transmission signal from the incidence plane and directs the incident transmission signal toward the light detector. In this arrangement, the guide portion has an interface which is tapered down from the incidence plane toward the light detector.

A projection display device in a second aspect of the present invention has a remote control receiver which receives light for exercising remote control as a transmission signal. In this arrangement, the remote control receiver includes: a light detector which receives the transmission signal; and a guide portion which has an incidence plane to which the transmission signal is entered, and refracts the incident transmission signal from the incidence plane to direct the incident transmission signal toward the light detector. In addition, the guide portion has an interface which is tapered down from the incidence plane toward the light detector.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams (perspective views) showing an external construction of a projector embodying the invention.

FIG. 2 is a diagram (bottom view) showing an external construction of the projector as the embodiment.

FIG. 3 is a diagram showing an internal structure of the projector as the embodiment.

FIG. 4 is a diagram schematically showing an arrangement of a projection optical unit in the embodiment.

FIGS. 5A to 5C are diagrams showing an arrangement of a remote control receiving unit in the embodiment;

FIGS. 6A and 6B are diagrams for describing manners of receiving signal light by the remote control receiving unit in the embodiment;

FIG. 7 is a diagram for describing a manner of receiving signal light by the remote control receiving unit in the embodiment;

FIGS. 8A to 8C are diagrams showing results of simulation of a light-guiding member in the embodiment and a light-guiding member without a depressed portion, concerning change characteristics in light guiding rate with respect to an incident angle α of emitted light flux; and

FIGS. 9A and 9B are diagrams showing arrangements of light-guiding members in modification examples.

The drawings are provided mainly for describing the present invention, and do not intended to limit the scope of the present invention.

### DESCRIPTION OF PREFERRED EMBODIMENTS

An embodiment of the present invention will be described below with reference to the drawings.

In this embodiment, a remote control receiving unit 25 corresponds to a “remote control receiver” recited in the claims. A light-receiving portion 301 corresponds to a “guide portion” recited in the claims. A light-receiving plane 301a corresponds to an “incidence plane” recited in the claims. A light-guiding portion 302 corresponds to a “guide portion” recited in the claims. A depressed portion 303 corresponds to a “concave” recited in the claims. A side surface 303a corresponds to an “interface” recited in the claims. A light-receiving module 401 corresponds to a “light detector” recited in the claims. The foregoing correspondences in description between the claims and the embodiment are merely examples, and are not intended to limit the claims by this embodiment.

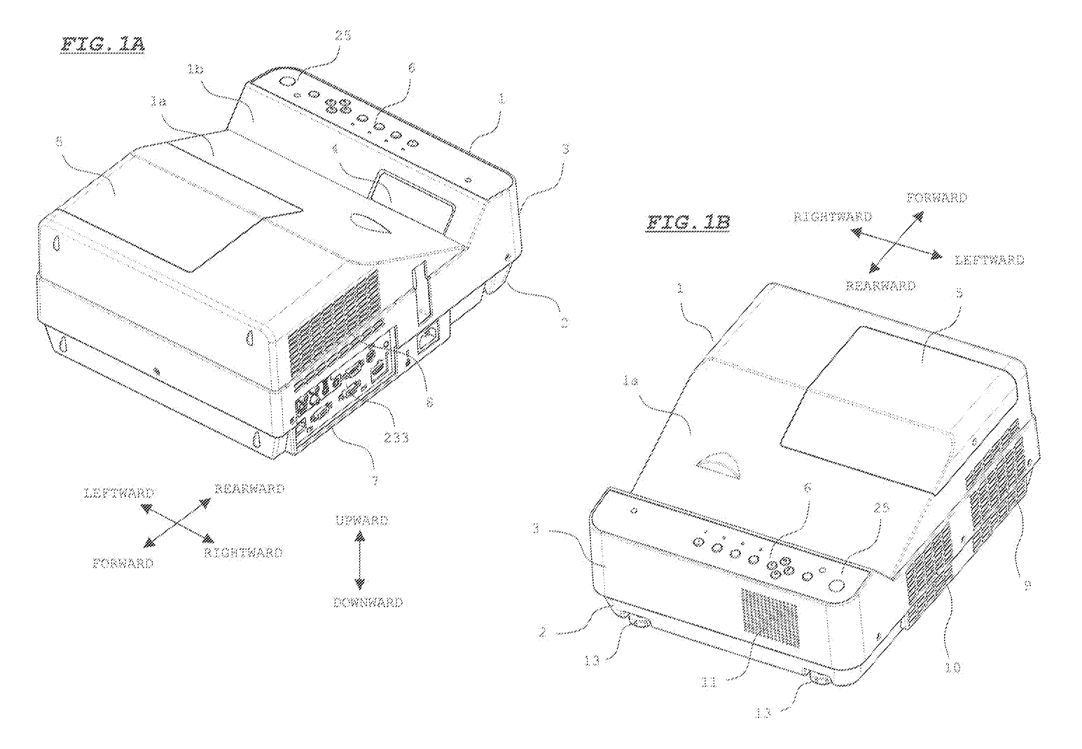

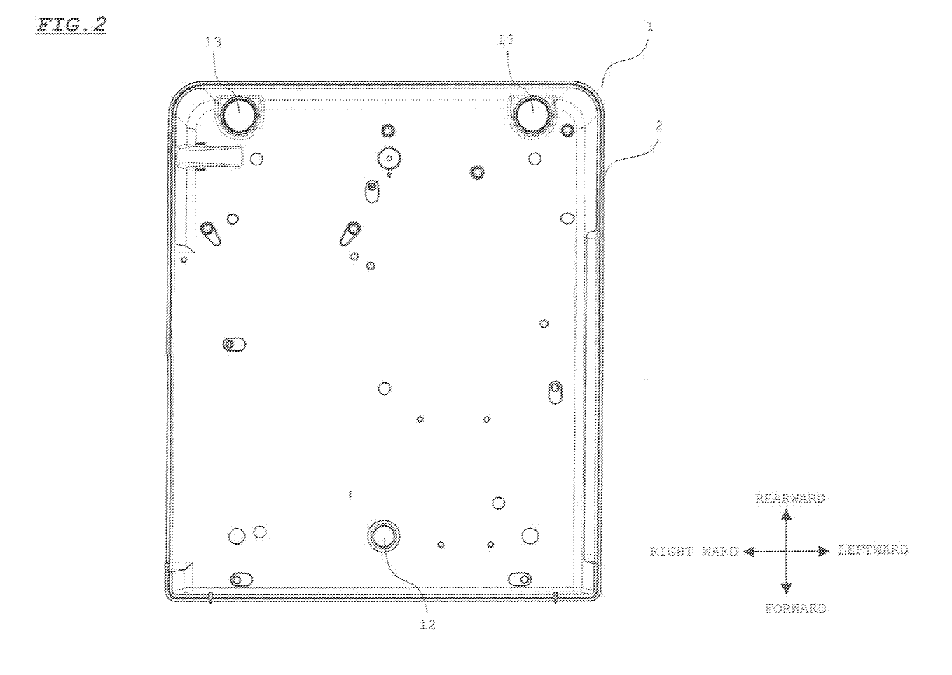

FIGS. 1A, 1B and FIG. 2 are diagrams showing an external construction of a projector embodying the invention. FIG. 1A is a perspective view of the projector when viewed from a front side, and FIG. 1B is a perspective view of the projector when viewed from a rear side. FIG. 2 is a bottom view of the projector. To simplify the description, arrows respectively indicating forward, rearward, leftward, and rightward directions, and arrows each indicating upward and downward directions are depicted in FIGS. 1A, 1B and FIG. 2. Hereinafter, the arrows indicating forward, rearward, leftward, and rightward directions are depicted in the same manner as above in the other drawings, as necessary.

The projector of the embodiment is a so-called short focus projector. Referring to FIGS. 1A and 1B, the projector is provided with a main body cabinet 1 having a substantially rectangular parallelepiped shape. The main body cabinet 1 is constituted of a lower cabinet 2, and an upper cabinet 3 which is placed on the lower cabinet 2 from above.

A top surface of the main body cabinet 1 is formed with a first slope 1a inclined downward and rearward, and a second slope 1b continuing from the first slope 1a and inclined upward and rearward. The second slope 1b faces obliquely upward and forward, and a projection port 4 is formed in the second slope 1b. Image light emitted obliquely upward and forward through the projection port 4 is enlarged and projected onto a screen disposed in front of the projector.

Further, the top surface of the main body cabinet 1 is formed with a lamp cover 5. The top surface of the main body cabinet 1 is formed with a lamp opening for use in exchanging a lamp unit, and a filter opening for use in exchanging a filter disposed in a fan unit for cooling the lamp unit. The lamp cover 5 is a cover for covering the lamp opening and the filter opening. Further, the top surface of the main body cabinet 1 is provided with an operation portion 6 constituted of a plurality of operation keys.

A terminal port portion 7 is formed in a right surface of the main body cabinet 1. A terminal panel 233 having various terminals such as AV terminals is attached to the terminal port portion 7. The terminal panel 233 constitutes a part of a control circuit unit to be described later. Audio Visual (AV) signals such as an image signal and an audio signal are inputted and outputted to and from the projector through the AV terminals. Further, an air inlet 8 is formed in the right surface of the main body cabinet 1 at a position above the terminal port portion 7. The air inlet 8 is constituted of multitudes of slit holes, and external air is drawn into the main body cabinet 1 through the air inlet 8.

A first air outlet 9 is formed in a front portion on a left surface of the main body cabinet 1, and a second air outlet 10 is formed in a middle portion on the left surface of the main body cabinet 1. Each of the first and second air outlets 9, is constituted of multitudes of slit holes, and air inside the main body cabinet 1 is discharged to the outside of the projector through the first and second air outlets 9, 10. Further, a sound output port 11 is formed in a rear surface of the main body cabinet 1. Sounds in accordance with images are outputted through the sound output port 11 at the time of image projection.

Referring to FIG. 2, a fixed leg 12 is disposed in the middle of a front portion on a bottom surface of the main body cabinet 1, and two adjustable legs 13 are disposed at a rear end thereof. By expanding or contracting the two adjustable legs 13 up and down, it is possible to adjust the inclination of the main body cabinet 1 in forward/rearward directions and leftward/rightward directions. Thus, it is possible to adjust the upward/downward position and the leftward/rightward inclination of an image projected on a screen.

The projector of the embodiment may be installed in a suspended state from a ceiling with the main body cabinet 1 being upside down, other than an installation manner that the bottom surface of the main body cabinet 1 is placed on an installation plane such as a desk surface or a floor surface. Further, a front surface of the main body cabinet 1 is a flat surface without the terminal panel 233 and the air inlet 8. Accordingly, it is possible to install the projector of the embodiment in such a manner that the front surface of the main body cabinet 1 is placed on an installation plane. In this case, an image is projected on the installation plane itself.

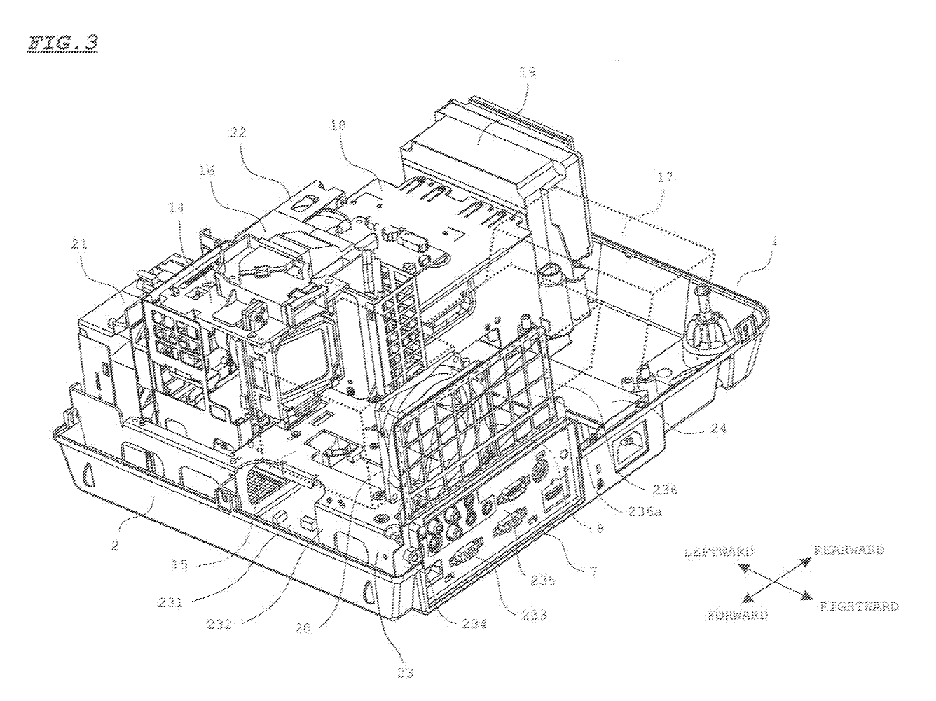

FIG. 3 is a diagram showing an internal structure of the projector. FIG. 3 is a perspective view showing a state that the upper cabinet 3 is detached, when viewed from a front side. To simplify the description, in FIG. 3, an imager unit 15 and a projection optical unit 17 are indicated by the dotted lines. Further, the position of the air inlet 8 is indicated by the one-dotted chain line.

Referring to FIG. 3, a lamp unit 14, and the imager unit 15 for modulating light from the lamp unit 14 to generate image light are disposed on a front portion of the lower cabinet 2.

The lamp unit 14 is constituted of a light source lamp, and a lamp holder for holding the light source lamp; and is configured so as to be detachably attached from above. A fan unit 16 is disposed behind the lamp unit 14. The fan unit 16 supplies external air (cooling air) drawn through the air inlet 8 to the light source lamp to cool the light source lamp. The lamp holder is formed with an air duct for guiding the cooling air from the fan unit 16 to the light source lamp.

The imager unit 15 includes a color wheel and a Digital Micromirror Device (DMD). The color wheel separates white light from the light source lamp into light of respective colors such as red, green, blue in a time-sharing manner. The DMD modulates the light of the respective colors emitted from the color wheel based on an image signal.

The projection optical unit 17 is disposed at a rear position of the imager unit 15. The projection optical unit 17 enlarges image light generated by the imager unit 15, and projects the enlarged image light onto a projection plane such as a screen.

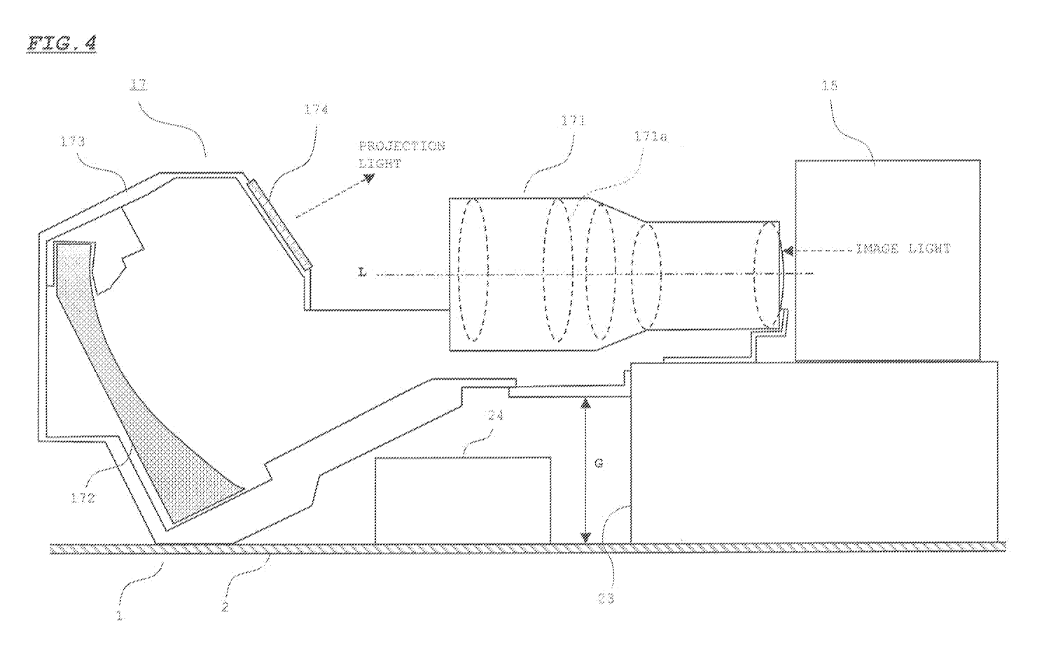

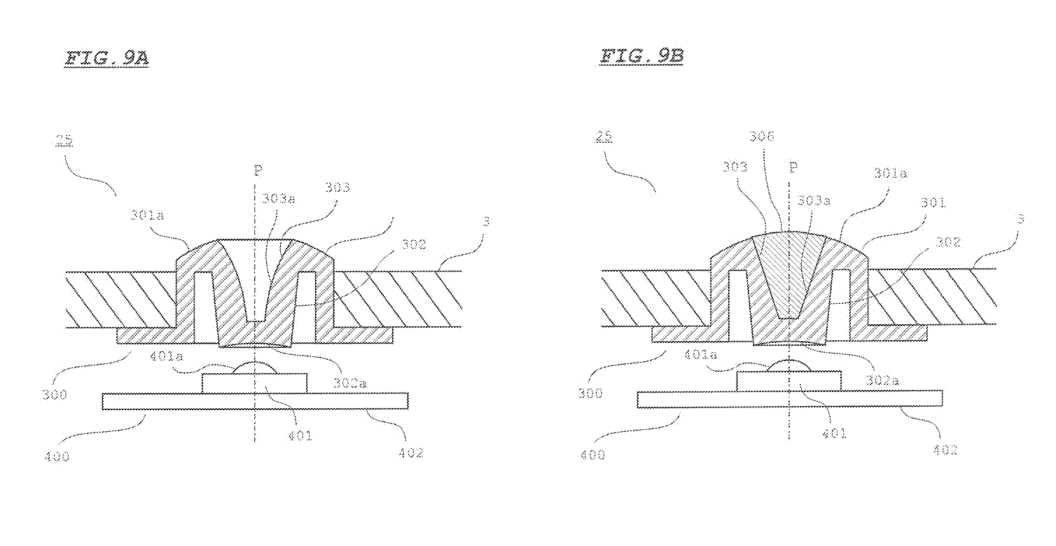

FIG. 9 is a diagram schematically showing an arrangement of the projection optical unit 17. In FIG. 4, the imager unit 15, a control circuit unit 23, and a noise filter unit 24 are schematically shown, in addition to the projection optical unit 17.

The projection optical unit 17 is constituted of a projection lens unit 171, a reflection mirror 172, and a housing 173 for housing the projection lens unit 171 and the reflection mirror 172. The projection lens unit 171 has a plurality of lenses 171a. The reflection mirror 172 is a curved mirror or a free curved mirror.

As shown in FIG. 4, image light emitted from the imager unit 15 is entered into the projection lens unit 171 at a position shifted from the optical axis L of the projection lens unit 171 in a direction toward the top surface of the main body cabinet 1. The entered image light is provided with a lens action by the projection lens unit 171, and is entered into the reflection mirror 172. Thereafter, the projection angle of the image light is expanded by the reflection mirror 172, and the image light is projected onto a projection plane (screen) via a light ray passage window 174.

As described above, image light is entered into the projection lens unit 171 at a position shifted from the optical axis L of the projection lens unit 171 in a direction toward the top surface of the main body cabinet 1. In view of this, the reflection mirror 172 is disposed at a position shifted from the optical axis L of the projection lens unit 171 toward the bottom surface of the main body cabinet 1. Here, the reflection mirror 172 has a reflection surface larger than the lens surface of each lens 171a constituting the projection lens unit 171. Accordingly, the shift amount of the reflection mirror 172 with respect to the optical axis L of the projection lens unit 171 is relatively large. Consequently, there is defined a relatively large space G between a lower surface of the projection lens unit 171 and the bottom surface of the main body cabinet 1 (lower cabinet 2). The space G is defined from the position where the projection lens unit 171 is disposed to the position where the imager unit 15 is disposed.

Referring back to FIG. 3, a power source unit 18 is disposed behind the fan unit 16. The power source unit 18 is provided with a power source circuit to supply electric power to each electric component of the projector. A speaker 19 is disposed behind the power source unit 18. Sounds outputted through the speaker 19 are released to the outside through the sound output port 11.

A DMD cooling fan 20 is disposed on the right of the imager 15. The DMD cooling fan 20 supplies external air drawn through the air inlet 8 to the imager unit 15 so as to cool the DMD. The DMD is sealably disposed in the imager unit 15, so that the DMD is kept from being directly contacted with the supplied external air.

A first exhaust unit 21 is disposed on the left of the lamp unit 14. The first exhaust unit 21 discharges air that has cooled the light source lamp to the outside through the first air outlet 9. The first exhaust unit 21 also discharges air that has cooled the DMD to the outside through the first air outlet 9.

A second exhaust unit 22 is disposed on the left of the power source unit 18. The second exhaust unit 22 discharges air that has been warmed in the inside of the power source unit 18 to the outside through the second air outlet 10. By flowing air from the inside of the power source unit 18 to the second exhaust unit 22, fresh external air is supplied into the power source unit 18 through the air inlet 8.

As shown in FIG. 3 and FIG. 4, in the projector of the embodiment, the control circuit unit 23 and the noise filter unit 24 are disposed in the space G defined below the projection lens unit 171 and the imager unit 15.

The noise filter unit 24 is provided with a circuit board mounted with a noise filter and a fuse thereon, and supplies electric power inputted from a commercial AC power source to the power source unit 18 after noise removal.

The control circuit unit 23 includes a control circuit board 231, a holder 232 for holding the control circuit board 231, the terminal panel 233, and a fixing board 234 for fixing the terminal panel 233.

A control circuit for controlling various driving components such as a light source lamp and a DMD is mounted on the control circuit board 231. Further, various terminals 235 are mounted on the control circuit board 231.

The terminal panel 233 is formed with various openings of the shapes in accordance with the shapes of the terminals 235. The terminals 235 are exposed to the outside through the openings. Although not illustrated, the fixing board 234 is formed with openings through which the terminals 235 pass, as well as the terminal panel 233.

The fixing board 234 is made of a metal material, and a shielding portion 236 is formed on an upper portion thereof. The shielding portion 236 is formed with multitudes of openings 236a, and a metal mesh (not shown) is attached to each of the openings 236a. The shielding portion 236 is disposed on the inside of the air inlet 8 to block electromagnetic wave from leaking to the outside through the air inlet 8. External air drawn through the air inlet 8 is supplied to the inside of the main body cabinet 1 through the openings 236a.

As shown in FIGS. 1A and 1B, the remote control receiving unit 25 is disposed on the upper surface of the main body cabinet 1 (upper cabinet 3) in the rear portion and is situated on the left of the operation portion 6. The remote control receiving unit 25 receives signal light (transmission signals) of infrared rays from a remote control transmitter (not shown), and outputs signals in accordance with the light to the control circuit board 231. The user thus can control remotely the projector by operating the remote control transmitter.

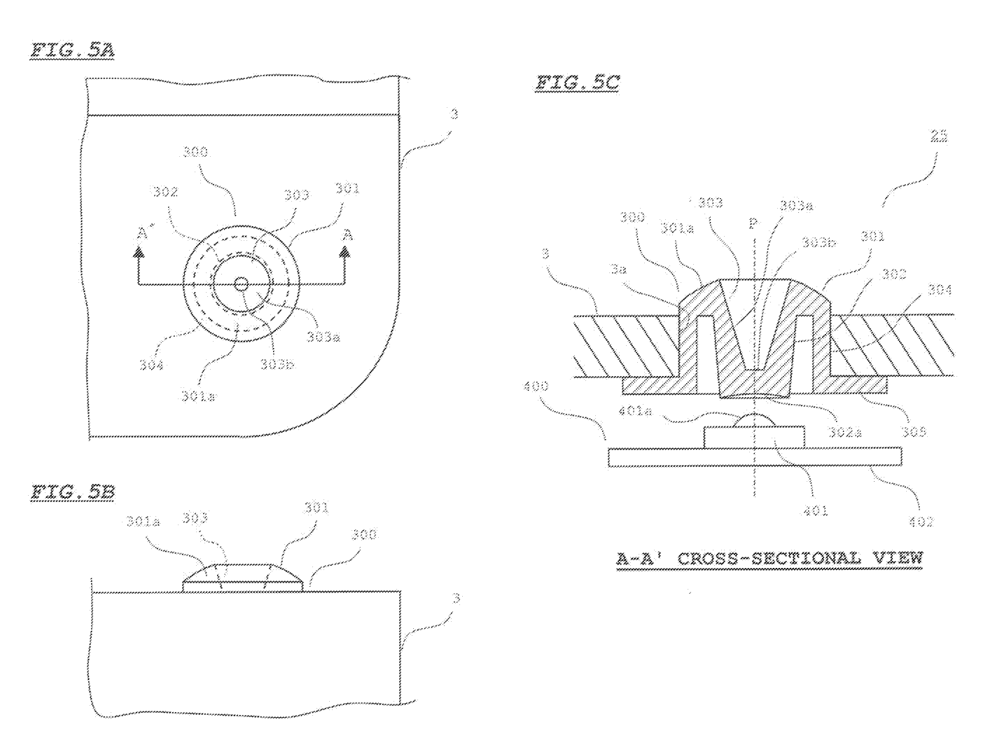

FIGS. 5A to 5C are diagrams showing an arrangement of the remote control receiving unit 25. FIG. 5A is a top view of the upper cabinet 3 and FIG. 5B is a side view of the same as seen from behind, in both of which a disposition part of the remote control receiving unit 25 is enlarged. FIG. 5C is a cross-sectional view of FIG. 5A taken along a line A-A′.

Referring to FIGS. 5A to 5C, the remote control receiving unit 25 includes a light-guiding member 300 and a remote control receiving circuit 400.

The light-guiding member 300 is made of a material with a high refractive index such as acrylic resin, and is disposed at a light-receiving window 3a on the upper cabinet 3. The light-guiding member 300 guides signal light having reached the light-receiving window 3a toward the remote control receiving circuit 400.

The light-guiding member 300 includes a light-receiving portion 301 projecting upward from the light-receiving window 3a. The light-receiving portion 301 has an almost disc shape. A front surface of the light-receiving portion 301, that is, a light-receiving plane 301a is formed in an almost spherical shape.

An approximately cylindrical light-guiding portion 302 is projected from a back surface of the light-receiving portion 301 toward the remote control receiving circuit 400. A lower end surface 302a of the light-guiding portion 302 has a concave curved shape.

The light-guiding member 300 has a depressed portion 303 at the center of the light-receiving plane 301a. The depressed portion 303 has a conical shape in which a leading end is horizontally cut, and ranges from the light-receiving plane 301a to a lower portion of the light-guiding portion 302. The depressed portion 303 has a side surface (peripheral surface) 303a tapered and inclined toward a center of the depressed portion. In addition, the depressed portion 303 has a bottom surface 303b made flat and vertical to a central axis P of the light-guiding member 300. The central axis P of the light-guiding member 300 is vertical to the top surface of the upper cabinet 3. The depressed portion 303 has a central axis aligned with the central axis P of the light-guiding member 300.

A cylindrical portion 304 surrounds the light-guiding portion 302 from an outer periphery of the light-receiving portion 301 toward the remote control receiving circuit 400. A flange portion 305 is formed at a lower end of the cylindrical portion 304. When the light-guiding member 300 is disposed at the light-receiving window 3a, the cylindrical portion 309 contacts an inner peripheral surface of the light-receiving window 3a, and the flange portion 305 contacts the back surface of the upper cabinet 3.

In the light-guiding member 300, the light-receiving portion 301 and the light-guiding portion 302 correspond to the guide portion in the present invention.

The remote control receiving circuit 400 includes a light-receiving module 401 and a substrate 402 on which the light-receiving module 401 is implemented. The light-receiving module 401 has light-receiving element and output electrical signal in accordance with the incident signal. The light-receiving module 401 has a spherical light-receiving plane 401a. The light-receiving module 401 forms predetermined receivable angles (for example, ±30 degrees) with respect to a direction vertical to the light-receiving plane 401a, and decreases significantly in light-receiving efficiency with respect to signal light at angles beyond the range of receivable angles. In addition to the light-receiving module 401, peripheral circuit components thereof are implemented on the substrate 402.

The remote control receiving circuit 400 is disposed within the main body cabinet 1 such that the light-receiving module 401 is opposed to the light-guiding portion 302 of the light-guiding member 300 with a predetermined space therebetween. For example, the upper cabinet 3 has on the back surface attachment bosses (not shown) to which the substrate 902 is screwed. In this arrangement, the center of the light-receiving plane 901a of the light-receiving module 401 is aligned with the central axis P of the light-guiding member 300.

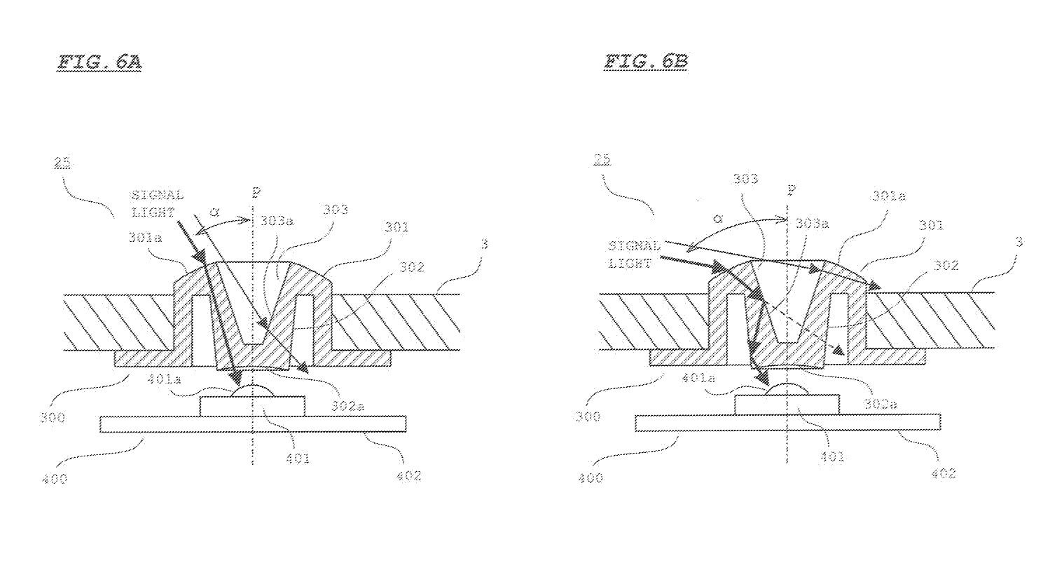

Next, manners of receiving signal light by the remote control receiving unit 25 will be described below with reference to FIGS. 6A, GB, and 7.

Since the remote control receiving unit 25 is disposed on the top surface of the main body cabinet 1, if the projector is installed in a stationary state, signal light can be entered into the remote control receiving unit 25 from front, rear, right, and left sides of the projector. If the projector is installed in a low position or a user is located close to the projector, signal light can be transmitted to the projector from a relatively high position. In this case, the incident angle α of signal light becomes relatively small, in a direction vertical to the light-receiving plane 401a of the light-receiving module 901, that is, with respect to the central axis P, as shown in FIG. 6A.

If the incident angle α is relatively small, out of signal light (light flux) entered into the light-receiving portion 301, signal light which is entered into the light-receiving plane 301a and refracted by the light-receiving plane 301a in a direction in which an angle with respect to the central axis P becomes smaller as shown by a thick arrow in FIG. 6A, propagates through the light-guiding portion 302 and travels toward the light-receiving module 401. Then, the signal light is output from the lower end surface 302a of the light-guiding portion 302 and is received by the light-receiving module 401. Meanwhile, signal light entered into the depressed portion 303 is not refracted by the light-receiving plane 301a, and thus may be emitted from the light-guiding member 300 depending on the incident angle α without traveling toward the light-receiving module 401 as shown by a thin arrow in FIG. 6A.

Next, if the projector is installed in a high position or a user is located distant from the projector, signal light can be transmitted to the projector from a relatively low position. In this case, the incident angle α of signal light with respect to the central axis P becomes relatively large.

If the incident angle α is relatively large, out of signal light (light flux) entered into the light-receiving portion 301, signal light which is entered into the light-receiving plane 301a and refracted by the light-receiving plane 301a in a direction in which an angle with respect to the central axis P becomes smaller as in the case described above, is not changed in direction until the signal light travels toward the light-receiving module 401, as shown by a thick arrow in FIG. 6B. Accordingly, the signal light propagates through the light-guiding portion 302 so as to travel toward the depressed portion 303, not toward the light-receiving module 401. Then, the signal light contacts the side surface 303a of the depressed portion 303 at a shallow angle.

The side surface 303a of the depressed portion 303 constitutes an interface between the light-guiding portion 302 and an air layer. The light-guiding portion 302 and the air are different in refraction index. Accordingly, most of the signal light having contacted the side surface 303a is reflected by the side surface 303a and travels more downward than before the reflection. Then, the signal light contacts the side surface (peripheral surface) of the light-guiding portion 302 at a shallow angle. Most of the signal light is reflected so as to travel toward the light-receiving module 401, and is output from the lower end surface 302a of the light-guiding portion 302, and then is received by the light-receiving module 401. If the signal light is entered into the side surface 303a of the depressed portion 303 at an extremely shallow angle, the reflected signal light may travel directly toward the light-receiving module 401, not toward the side surface of the light-guiding portion 302.

If the light-guiding member 300 does not have the depressed portion 303 unlike this embodiment, the signal light not traveling toward the light-receiving module 401 contacts the side surface (peripheral surface) of the light-guiding portion 302 at a relatively deep angle as shown by a dashed arrow in FIG. 6B. Accordingly, most of the signal light leaks directly outward, without being received by the light-receiving module 401.

Meanwhile, out of the signal light (light flux) entered into the light-receiving portion 301, light entered into the depressed portion 303 is emitted from the light-guiding member 300 without traveling toward the light-receiving module 401 as shown by a thin arrow in FIG. 6B, as in the case with the larger incident angle α.

As is described above, whether the incident angle α is large or small, all the signal light entered into the light-receiving portion 301 does not travel toward the light-receiving module 401. In this embodiment, the sensitivity of the light-receiving module 401 is set such that remote control is enabled depending on an amount of signal light (amount of received light) entered into the light-receiving module 401, as shown by the thick arrows in FIGS. 6A and 6B.

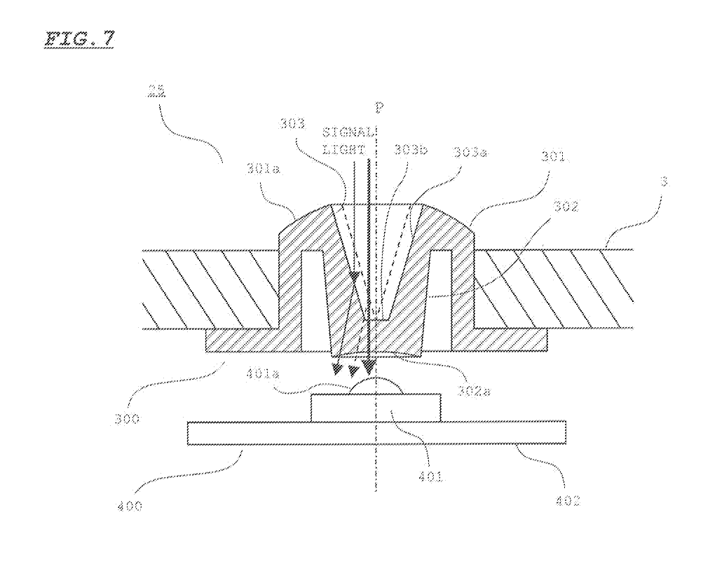

Next, as shown in FIG. 7, if signal light is transmitted from almost immediately above the projector and entered into the light-receiving portion 301 in almost parallel with the central axis P, out of the signal light (light flux), signal light entered into the light-receiving plane 301a propagates through the light-guiding portion 302 and travels toward the light-receiving module 401.

Meanwhile, part of the signal light having entered into the depressed portion 303 may contact the side surface 303a of the depressed portion 303 and be refracted by the side surface 303a without traveling toward the light-receiving module 401, as shown by a thin arrow in FIG. 7. However, since the depressed portion 303 has a flat bottom surface 303b, signal light close to the central axis P is entered into the bottom surface 303b and received by the light-receiving module 401 through the light-guiding portion 302, as shown in a thick arrow in FIG. 7. Accordingly, even though the light-guiding member 300 has the depressed portion 303, the light-receiving module 401 can be enhanced in light-receiving efficiency as much as possible if signal light is transmitted from a position close to the front surface of the remote control receiving unit 25.

If the depressed portion 303 does not have the flat bottom surface 303b as shown by a dashed line in FIG. 7, signal light close to the central axis P may also be refracted by the side surface 303a as shown by a dashed arrow in FIG. 7, and therefore the signal light may not be received by the light-receiving module 401.

According to this embodiment as described above, it is possible to guide signal light at the incident angle α which cannot be guided toward the light-receiving module 401 only by refraction on the light-receiving plane 301a of the light-receiving portion 301, toward the light-receiving module 401 by reflection on the side surface 303a of the depressed portion 303. This allows the remote control receiving unit 25 to receive transmission signals from a wide area. In addition, it is possible to lengthen a reception distance of transmission signals directed to the front surface of the light-guiding member 300 (top surface of the projector) from a lateral direction. Therefore, remote control can be smoothly performed.

Further, it is possible to widen a reception area simply by forming the depressed portion 303 in the light-guiding member 300, without the need to provide a dedicated member separately from the light-guiding member 300. Accordingly, the remote control receiving unit 25 can be simplified in structure, thereby suppressing cost increase and the like.

Moreover, since the depressed portion 303 (side surface 303a) is configured to have a conical shape, transmission signals can be evenly reflected on the interface from any direction at 360 degrees. Therefore, it is possible to enhance the remote control receiving unit 25 in light-receiving sensitivity, evenly with respect to transmission signals from any direction.

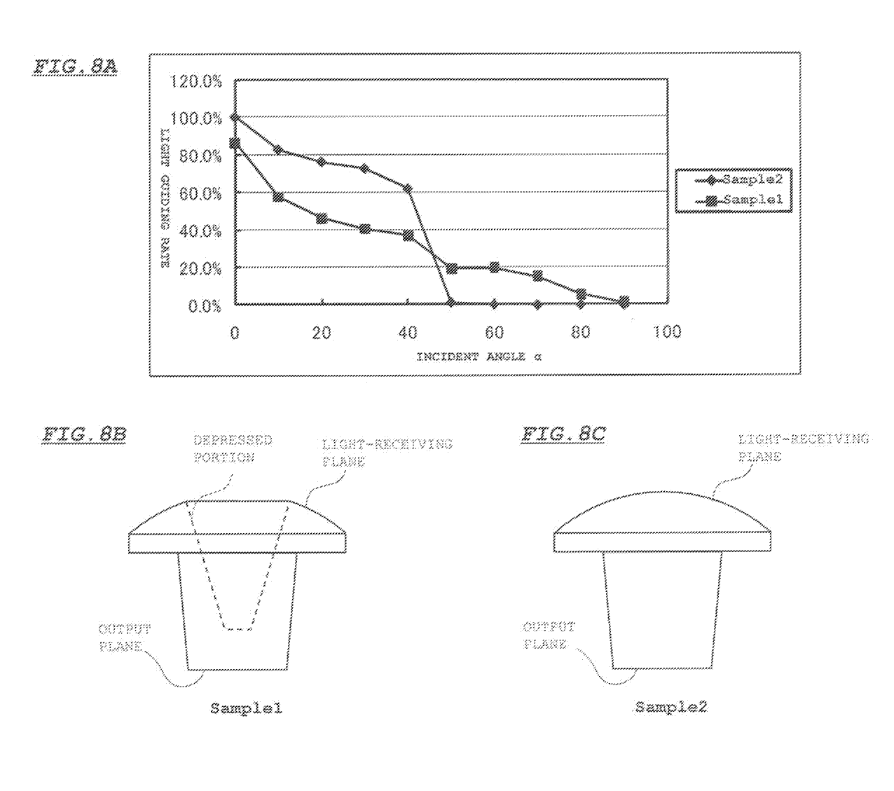

FIGS. 8A to 8C are diagrams showing results of simulation of a light-guiding member in this embodiment and a light-guiding member without a depressed portion, concerning change characteristics in light guiding rate with respect to an incident angle α of emitted light flux. FIG. 8A is a graph of the simulation results in which a vertical axis denotes the light guiding rate and a lateral axis denotes the incident angle α. FIGS. 8B and 8C depict light-guiding members used for the simulation: FIG. 8B shows a light-guiding member configured identical to this embodiment (Sample 1); and FIG. 8C shows a light-guiding member without the depressed portion 303 (Sample 2). In describing the both light-guiding members of FIGS. 8B and 8C, the cylindrical portion 304 and the flange portion 305, not contributing to light guiding, are omitted.

In this simulation, the percentage of an amount of light flux emitted from an output plane with respect to an amount of the same received on the light-receiving panel, is represented as light guiding rate. In addition, it is assumed that the density of emitted light flux is constant and a variable range of incident angle α is 0° to 90°.

As is apparent from the graph of FIG. 8A, the light-guiding member without the depressed portion 303 (Sample 2) becomes high in light guiding rate as far as the incident angle α is relatively small because most of the light flux reaches the output plane by refraction on the light-receiving plane; However, when the incident angle α exceeds a level in which the light flux cannot travel toward the output plane only by the refraction, the light guiding rate of the light-guiding member extremely decreases and becomes close to zero.

Meanwhile, the light-guiding member with the depressed portion 303 (Sample 1) configured identical to this embodiment, makes it possible to direct the light flux not traveling toward the output plane only by the refraction, toward the output plane by reflection on the side surface 303a of the depressed portion 303, as described above (refer to FIG. 6B). Accordingly, although the light-guiding member with the depressed portion 303 is slightly lower in light guiding rate than the light-guiding member without the depressed portion 303 while the incident angle α is small, the light-guiding member with the depressed portion 303 can maintain a certain level of light guiding rate without extreme decrease even if the incident angle α becomes larger.

As is understood from the foregoing simulation results, using the light-guiding member 300 of this embodiment allows the remote control receiving unit 25 to receive transmission signals from a wide area.

Although an embodiment of the present invention is as described above, the present invention is not limited to this embodiment. In addition, the embodiment of the present invention can further be modified in various manners besides the foregoing ones.

For example, in the foregoing embodiment, the side surface 303a of the depressed portion 303 constituting the interface is formed in a conical shape. However, the side surface 303a may not necessarily have a conical shape as far as the same is configured to be tapered and inclined. For example, the side surface 303a may be curved so as to swell up toward the central axis of the depressed portion 303, as shown in FIG. 9A.

In addition, in the foregoing embodiment, the depressed portion 303 is hollow and open at a top, and is configured to have an interface between the light-guiding portion 302 and an air layer. However, the depressed portion 303 is not limited to this arrangement, and may be filled with a filling member 306 different in refraction rate from the light-guiding portion 302, as shown in FIG. 9B. The filling member 306 is formed in accordance with the shape of the depressed portion 303, and is configured to have a curved top surface similar to the light-receiving plane 301a. Providing the filling member 306 avoids accumulation of dust and the like in the depressed portion 303.

The filling member 306 is desirably made of a material with which a difference in refraction rate between the filling member 306 and the light-guiding portion 302 becomes larger than that between the air and the light-guiding portion 302. This makes it possible to increase a reflection rate on the interface and further enhance the light-receiving module 401 in light-receiving efficiency.

In addition, in the foregoing embodiment, the depressed portion 303 has the flat bottom surface 303b. However, the depressed portion 303 may not necessarily have the bottom surface 303b as far as the light-receiving module 401 sufficiently receives signal light having entered into the light-receiving member 300 from almost immediately above the projector (in almost parallel with the central axis P of the light-guiding member 300).

Further, in the foregoing embodiment, the light-receiving plane 301a is formed in an almost spherical shape. Alternatively, the light-receiving plane 301a may be formed flat. Nevertheless, the light-receiving plane 301a is desirably formed in an almost curved shape such as an almost spherical shape, thereby to suppress reflection of signal light on the light-receiving plane 301a so that the signal light is likely to be captured into the light-guiding member 300 if the incident angle α is large.

Moreover, in the foregoing embodiment, a remote control receiver of the present invention is applied to a projector. Alternatively, the remote control receiver of the present invention may be applied to other electrical devices.

Besides, the embodiment of the present invention can be modified in various manners as appropriate within the scope of a technical idea recited in the claims.

What is claimed is:

1. A remote control receiver which receives light for exercising remote control as a transmission signal, comprising:
a light detector which receives the transmission signal; and
a guide portion which has an incidence plane to which the transmission signal is entered, and refracts the incident transmission signal from the incidence plane and directs the incident transmission signal toward the light detector, wherein
the guide portion has an interface which is tapered down from the incidence plane toward the light detector.

2. A remote control receiver according to claim 1, wherein
the interface has a conical shape, and
the light detector is disposed on a central axis of the conical shape.

3. A remote control receiver according to claim 2, wherein
the'interface has at an apex of the conical shape a bottom surface made flat in a direction vertical to the central axis.

4. A remote control receiver according to claim 1, wherein
the guidance portion has a concave depressed from the incidence plane to the light detector, and
the interface is formed between the concave and a medium within the concave.

5. A remote control receiver according to claim 4, wherein
the incidence plane has an opening through which the concave is open outward.

6. A projection display device having a remote control receiver which receives light for exercising remote control as a transmission signal, the remote control receiver comprising:
a light detector which receives the transmission signal; and
a guide portion which has an incidence plane to which the transmission signal is entered, and refracts the incident transmission signal from the incidence plane and directs the incident transmission signal toward the light detector, wherein
the guide portion has an interface which is tapered down from the incidence plane toward the light detector.

7. A projection display device according to claim 6, wherein
the interface has a conical shape, and
the light detector is disposed on a central axis of the conical shape.

8. A projection display device according to claim 7, wherein
the interface has at an apex of the conical shape a bottom surface made flat in a direction vertical to the central axis.

9. A projection display device according to claim 6, wherein
the guidance portion has a concave depressed from the incidence plane to the light detector, and
the interface is formed between the concave and a medium within the concave.

10. A projection display device according to claim 9, wherein
the incidence plane has an opening through which the concave is open outward.
